(19) United States
(12) Patent Application Publication
(10) Pub. No.: US 2022/0168935 A1
(43) Pub. Date: Jun. 2, 2022

(54) CLASS A, CARBON FIBER-REINFORCED THERMOPLASTIC COMPOSITES THROUGH IN-MOLD COATING

(71) Applicant: Magna Exteriors Inc., Concord (CA)

(72) Inventors: Alexis Baltazar-y-Jimenez, Concord (CA); Siddhartha Asthana, Troy, MI (US); Brian A. Krull, Sterling Heights, MI (US)

(73) Assignee: Magna Exteriors Inc., Concord (CA)

(21) Appl. No.: 17/535,344

(22) Filed: Nov. 24, 2021

Related U.S. Application Data
(60) Provisional application No. 63/119,155, filed on Nov. 30, 2020.

(51) Int. Cl. B29C 45/16; B29C 45/00

(52) U.S. Cl. CPC B29C 45/1679; B29K 2077/00; B29C 45/0005; B29C 45/0001

(57) ABSTRACT

A method of injection molding of a class A surface part comprising the steps of first providing a first injections mold cavity for forming a part geometry and a second injection mold cavity for molding of a final class A surface around the part geometry with a second material. Then a fiber reinforced polyamide with an effective amount of an ABS material is compounded and the first injection mold cavity is used to form a part geometry. Thereafter, a colored polyurethane material is injected around the part geometry in the second injection molded cavity for providing a class A surface coating on the part.

### CROSS-REFERENCE TO RELATED APPLICATIONS

This application is a non-provisional patent application and claims benefit of U.S. Provisional Patent Application No. 63/119,155, filed Nov. 30, 2020. The disclosure of the above application is incorporated herein by reference.

### FIELD OF THE INVENTION

The present invention relates to a class A surface for carbon fiber-reinforced thermoplastic composites through in-mold coating.

### BACKGROUND OF THE INVENTION

The use of in-mold coating with unfilled thermoplastic resins such as: ABC, PC or PC/ABS, has been reported in the literature to achieve a superior cosmetic surface appearance in products ranging from automotive exterior parts to large household appliances. Nevertheless, the use of unfilled resins is not desirable in semi-structural automotive applications due to their lower mechanical properties if compared to advanced engineering resins, such as fiber reinforced PA6 (a Glass reinforced Polyamide available from DuPont). Global automotive trends seek to achieve lightweight and high impact properties and stiffness in vehicle parts. Typically, fiber reinforced PA6 is used in automotive parts with low cosmetic value. It is desirable to use this kind of resin in exterior automotive parts, like decklids, roof panels, composite liftgates and hoods if they could only achieve superior cosmetic appearance, or class A. Unfortunately, fiber reinforced PA6 has had limited success in achieving class A due to the waviness that the reinforcing fiber creates on the surface, and the poor compatibility between the OEM paint coatings and the PA6 substrate.

Orange peel and waviness on painted, reinforced carbon fiber-PA substrates. Is always a problem which in the past has limited some of the uses and finishes obtainable with such substrates.

Therefore it is an object of the present invention to achieve Short-Wave (SW) and orange peel values that match class A targets for OEMs.

In the past it is believed that the only other available solution to achieve class A on carbon fiber-PA6 substrates involves the use of BASF's iGloss® clear coat. In essence this requires coating an additional 50 microns on top of the standard 50 microns of clear coat and bake at lower temperature. This requires of significant capex and reduces the efficiency of the oven because it takes considerable time to reduce the temperature and heat up again.

Therefore, it is a goal in the art to provide an improved process of making a filled structural vehicle part which has a class A final surface.

### SUMMARY OF THE INVENTION

This invention disclosure reports on the use of ABS as compatibilizer between the in-mold coating and the reinforced-PA6 substrate to produce class A thermoplastic composites through in-mold coating.

A method of injection molding of a class A surface part comprising the steps of first providing a first injection mold cavity for forming a part geometry and a second injection mold cavity which includes a class a mold cavity for molding of a final class A surface around the part geometry with a second material. The process steps include a first step in which a fiber reinforced polyamide is compounded with an ABS material and the first injection mold cavity is used to form a part geometry. Thereafter, a colored polyurethane material is injected around the part geometry in the second injection molded cavity for providing a class A surface coating on the part.

Significant reduction in capex if compared to 2K primer solutions. In-mold coating offers a 2-step process (1: molding, 2: coating) inside the injection-molding machine with lower scrap-rate than traditional spray-paint line process.

A metered mixture of polyurethane resin is pumped into the cavity of a heated mold. The mold is closed and after curing, the part can be removed from the mold. As it exists the mold, the part, which is a fiber-reinforced thermoplastic composite, is already painted and has the desired smoothness, color, and aesthetics.

A fiber-reinforced PA6 & ABS thermoplastic, preferably carbon fiber-reinforced PA6 as substrate and a Poly Urethane (PU)-based in-mold coating. ABS is a critical component to provide proper adhesion and molding during the second urethane step. Preferably ABS is blended into the polyamide in an amount of 20% by weight. Typically, 15 to 25% by weight ABS is used. In preferred embodiments 15-20%, or about 20 to about 25% ABS is used.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description.

### DETAILED DESCRIPTION OF THE PREFERRED EMBODIMENTS

The following description of the preferred embodiment(s) is merely exemplary in nature and is in no way intended to limit the invention, its application, or uses. A method of injection molding of a class A surface part comprising the steps of first providing a first injection mold cavity for forming a part geometry and a second injection mold cavity for molding of a final class A surface around the part geometry with a second material. Then a fiber reinforced polyamide with an ABS material is compounded and the first injection mold cavity is used to form a part geometry. Thereafter, a colored polyurethane material is injected around the part geometry in the second injection molded cavity for providing a class A surface coating on the part. The coloration or pigment added to the urethane is for color matching to the final Class A finish desired.

The first material is selected from the group consisting of a polyamide ABS formulation; a carbon filled thermoplastic; PA6; PA6,6; graphene-enhanced PA6 and mixtures thereof.

In one embodiment a 20% carbon filled Polyamide 6 plus 20% by weight ABS available from Akro-Plastic GmbH, Industriegebiet Brohltal Ost, Lm Stiefelfeld 1, D56651 Niederzissen, Germany, or one of its affiliates, into a single pellet which is dropped into the injection molding machine. Generally, Polyamides useful in the present invention will be from about 20% to about 40% by volume carbon and/or glass fiber reinforced.

The injection molding machine is equipped with a rotating tool with one (1) core and two (2) cavities.

Cavity 1 is used to mold the part to the required geometry. Then the tool rotates and exposes the molded part into the second cavity.

In the second cavity, a PU mix which includes a colorant is injected to create a relatively thin, PU-based coating which cures on top of the part and inside the mold. Hence the name, in-mold coating. The Polyurethane material is selected from the group consisting of aliphatic polyisocyanate and mixtures thereof. Typically, the second cavity allows a thickness of polyurethane over the part geometry of from about 0.2 to 1.0 mm with a preferred thickness of about 0.6 mm

There is a limited number of colors available for in-mold coating so a compatible colorant is selected for the class A surface. This allows for a class A level smoothness in the final part which has a color close enough to the final predetermined final paint or finish of the vehicle for painting over or otherwise using as a final class A surface of a vehicle.

### EXAMPLES

The process was tested using a black puroclear 3351 iT mixed with a puronate 960/1 colorant in a ratio of 1:2.29 to create a colorized injection moldable polyurethane resin. Both of these resins are available from Ruhl Puromer GmbH of Friedrichsdorf, Germany. An XM 574 Krauss Maffei Spinform injection molding machine is used to accomplish the process.

In the first cavity a PA6 fiber filled material is used to create a part. This material has the following properties and ingredients: 20 wt.% carbon fiber PA6 and ABS.

The first injection molding is accomplished by injecting the thermoplastic mix comprised of carbon fiber and PA6 and ABS into the mold at a temperature of 240° C-260° C. Thereafter the mold is rotated into the second coating cavity and the polyurethane & isocynate material mix having a temperature of 65° C. and the following description: 100 g Puroclear 3351 IT and 229 g Puronate 960/1 is molded over the core at a temperature of 65° C.-85° C. with a pressure of 10-100 bar. The mold is allowed to cure for a period of at least 40 seconds. A Krauss Maffei Spinform injection molding machine is used in this process.

The final part is found to have a class A surface. There is found to be a significant reduction in capex if compared to 2K primer solution coatings. In-mold coating offers a 2-step process (1: molding, 2: coating) inside the injection-molding machine with lower scrap-rate than traditional spray-paint line process. Further understanding of the invention and testing data can be gleaned from Appendix A attached herewith as part of the present specification.

It is found that a metered mixture of polyurethane resin is pumped into the cavity of a heated mold. The mold is closed and after curing, the part can be removed from the mold. As it exists the mold, the part, which is a fiber-reinforced thermoplastic composite, is already painted and has the desired smoothness, color and aesthetics.

The same process is used using ABS content of 15, 20, and 25% in the first polymer that is 20 30 and 40% carbon fiber filled. The final part has a Class A surface. 0.2, 0.6 and 1.0 mm urethane moldings are found to produce acceptable Class A surface results.

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. A method of injection molding of a class A surface part comprising the steps of;
A. Providing a first injection mold cavity for forming a part geometry and a second injection mold cavity with a class A mold surface for molding of a final class A surface around the part geometry with a second material.
B. Compounding a fiber reinforced polyamide with an ABS material and using the first injection mold cavity to form a part geometry and
C. Utilizing a colored polyurethane material injected around the part geometry in the second injection molded cavity for providing a class A surface coating on the part.

2. The method of claim 1 wherein the fiber reinforced polyamide is carbon fiber or glass fiber reinforced.

3. The method of claim 1 wherein the mold has one (1) core and two cavities.

4. The method of claim 3 wherein the mold is a spin form injection mold.

5. The method of claim 1 where in the first material is selected from the group consisting of a poly amide with ABS formulation in which said poly amide is selected from; a carbon filled; PA6; PA6,6; graphene-enhanced PA6 and mixtures thereof.

6. The method of claim 1 wherein the Polyurethane material is selected from the group consisting of aliphatic polyisocyanate and mixtures thereof.

7. The method of claim 1 wherein the polyurethane material is molded in a layer from about 0.2 mm to about 1.0 mm thick.

8. The method of claim 1 wherein the polyurethane material is molded in a layer from 0.6 mm thick.

9. The method of claim 5 wherein the poly amide is from 20% to 40% glass fiber and or carbon fiber by volume.

10. The method of claim 1 wherein the ABS material is found in an amount of about 20% by weight of the polyamide compound.

11. The method of claim 1 wherein the ABS material is found in an amount of from about 15% by weight to about 20% by weight of the polyamide compound.

12. The method of claim 1 wherein the ABS material is found in an amount of from about 20% by weight to about 25% by weight of the polyamide compound.
